(19) United States
(12) Patent Application Publication
(10) Pub. No.: US 2026/0105083 A1
(43) Pub. Date: Apr. 16, 2026

(54) INFORMATION PROCESSING APPARATUS

(71) Applicant: RevComm Inc., Tokyo (JP)

(72) Inventors: Shiho INOUE, Shibuya-ku (JP); Masaki ONO, Shibuya-ku (JP)

(73) Assignee: RevComm Inc., Tokyo (JP)

(21) Appl. No.: 19/421,203

(22) Filed: Dec. 16, 2025

Related U.S. Application Data
(63) Continuation of application No. PCT/JP2023/030069, filed on Aug. 22, 2023.

(51) Int. Cl. G06F 16/3329; G10L 15/00

(52) U.S. Cl. CPC G06F 16/33295; G10L 15/005

(57) ABSTRACT

An information processing apparatus for processing information on a dialog between a plurality of users, the apparatus includes processing circuitry configured to: acquire analysis data obtained by analyzing the dialog; and create input data to be input to a generative AI, based on the acquired analysis data.

### CROSS-REFERENCE TO RELATED APPLICATIONS

This application is based upon and claims the benefit of priority from the prior PCT Patent Application No. PCT/JP2023/030069, filed Aug. 22, 2023, the entire contents of which are incorporated herein by reference.

### FIELD

The present disclosure relates to an information processing apparatus.

### BACKGROUND

Technology for analyzing call information is known.

Conventional System discloses a technique for analyzing call information.

There is a problem that it is difficult for a user to understand the content of analysis data relating to a dialog performed between a plurality of users when the user only receives the presentation of the analysis data.

### SUMMARY

Therefore, this disclosure is made to solve the above problem, and its object is to provide a technique for creating input data, such as a prompt, to be input to a generative AI, such as a large-scale language model, for obtaining a response content (feedback such as comments) in a manner that is easy for users to understand regarding analysis data relating to a dialog.

### BRIEF DESCRIPTION OF THE DRAWINGS

FIG. 1 is a block diagram showing a functional configuration of a system 1.

FIG. 2 is a block diagram showing a functional configuration of a server 10.

FIG. 3 is a block diagram showing a functional configuration of a first user terminal 20.

FIG. 4 is a block diagram showing a functional configuration of a second user terminal 30.

FIG. 5 shows a data structure of a user table 1012.

FIG. 6 shows a data structure of a group table 1013.

FIG. 7 shows a data structure of a dialog table 1014.

FIG. 8 shows a data structure of a label table 1015.

FIG. 9 shows a data structure of a voice segment table 1016.

FIG. 10 shows a data structure of a comment table 1021.

FIG. 11 is a flowchart showing an operation of comment processing.

FIG. 12 is a screen example showing the operation of the comment processing.

FIG. 13 is a block diagram showing a basic hardware configuration of a computer 90.

### DETAILED DESCRIPTION

In general, according to one embodiment, an information processing apparatus processing f information on a dialog between a plurality of users, the apparatus comprising processing circuitry configured to: acquire analysis data obtained by analyzing the dialog; and create input data to be input to a generative AI, based on the acquired analysis data.

Hereinafter, an embodiment of the present disclosure will be described with reference to the drawings. In all drawings illustrating the embodiment, common constituent elements are denoted by the same reference numeral, and repeated descriptions will be omitted. It should be noted that the following embodiment does not unduly limit the contents of the present disclosure described in the claims. In addition, not all of the constituent elements described in the present embodiment are essential constituent elements of the present disclosure. Furthermore, each figure is a schematic diagram and does not necessarily depict the actual structure with absolute precision.

### Configuration of System 1

A system 1 in the present disclosure is an information processing system that provides an information processing service for efficiently managing inquiries from customers by telephone or the like.

The system 1 includes information processing apparatuses of a server 10, a first user terminal 20, a second user terminal 30, a voice server (PBX) 50, and a generative AI 80, which are connected via a network N.

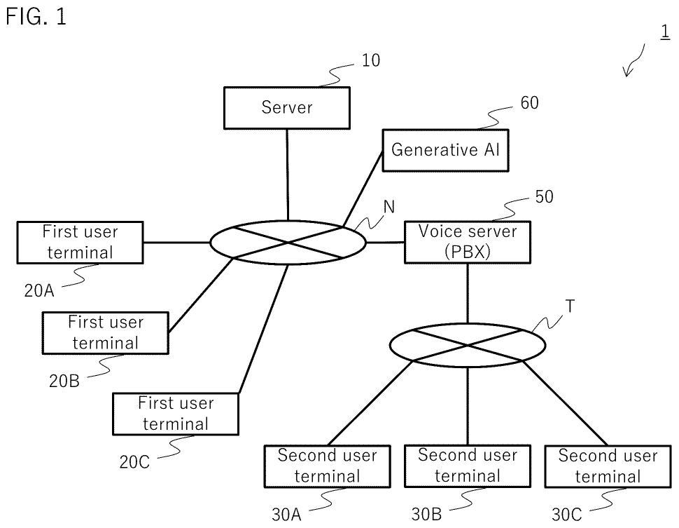

FIG. 1 is a block diagram showing a functional configuration of the system 1.

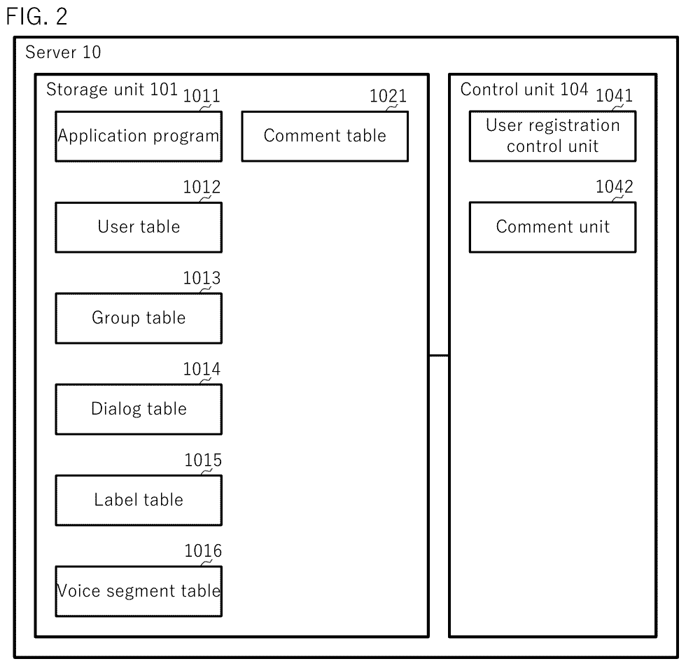

FIG. 2 is a block diagram showing a functional configuration of the server 10.

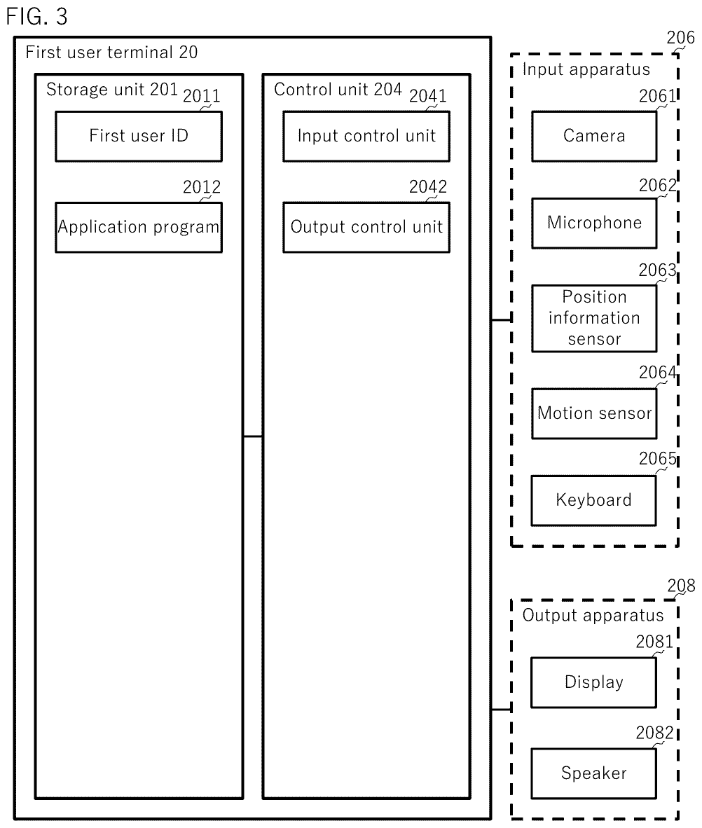

FIG. 3 is a block diagram showing a functional configuration of the first user terminal 20.

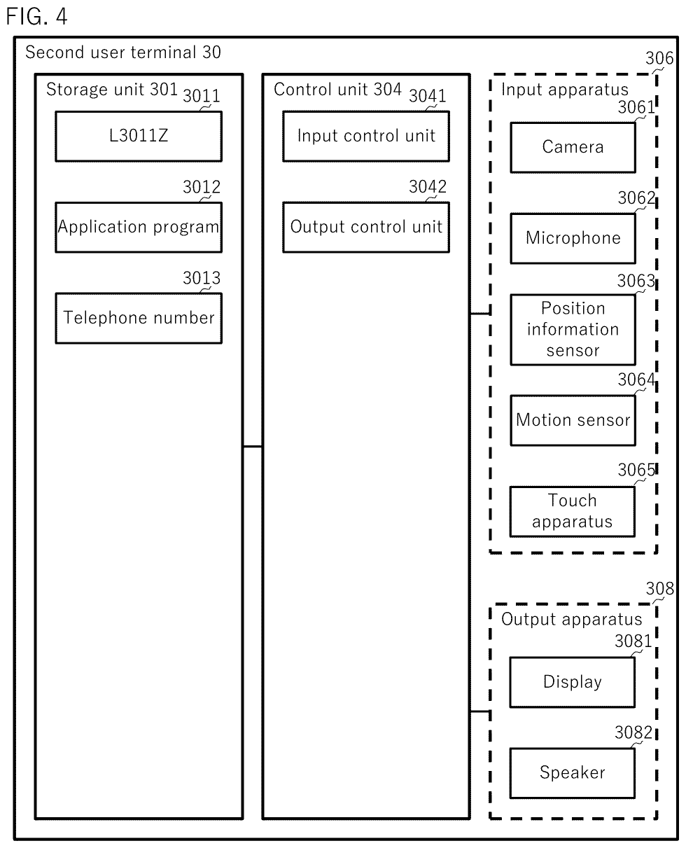

FIG. 4 is a block diagram showing a functional configuration of the second user terminal 30.

Each information processing apparatus is constituted by a computer including an arithmetic apparatus and a storage apparatus. A basic hardware configuration of the computer and a basic functional configuration of the computer realized by the hardware configuration will be described later. For each of the server 10, the first user terminal 20, the second user terminal 30, the voice server (PBX) 50, and the generative AI 80, descriptions redundant with the descriptions of the basic hardware configuration of the computer and the basic functional configuration of the computer to be provided later will be omitted.

### Configuration of Server 10

The server 10 is an information processing apparatus that provides an information processing service for executing predetermined information processing in response to an inquiry from a customer by telephone or the like.

The server 10 according to the present disclosure is an information processing apparatus that provides a dialog service (online dialog service) performed online between a first user who is an operator and a second user who is a customer. It should be noted that the server 10 according to the present disclosure may also be capable of providing a dialog service performed online among three or more users including a plurality of operators and a plurality of customers.

It is noted that the customer is not necessarily a user of the information processing service according to the present disclosure.

The server 10 includes a storage unit 101 and a control unit 104.

### Configuration of Storage Unit 101 of Server 10

The storage unit 101 of the server 10 includes an application program 1011, a user table 1012, a group table 1013, a dialog table 1014, a label table 1015, a voice segment table 1016, and a comment table 1021.

The application program 1011 is a program for causing the control unit 104 of the server 10 to function as each functional unit.

The application program 1011 includes applications, such as a web browser application.

The user table 1012 is a table for storing and managing information on users. When a user registers to use the service, information of the user is stored in a new record in the user table 1012. This enables the user to use the service according to the present disclosure. In the present disclosure, the user table 1012 is a table having columns of user ID, group ID, and user name with the user ID as the primary key.

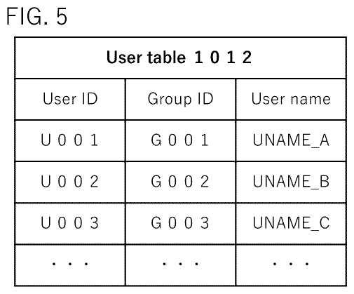

FIG. 5 shows a data structure of the user table 1012.

The user ID is an item for storing user identification information for identifying the user. The user identification information is an item of a unique value set for each user.

The group ID is an item for storing group identification information for identifying the group. Storing one or more pieces of group identification information in association with each user indicates that the user belongs to one or more groups.

The user name is an item for storing the name of the user. The user name may be any character string such as a nickname, rather than a full name.

The group table 1013 is a table for storing and managing information (group information) on groups to which users belong. The group includes companies, corporations, corporate groups, clubs, various organizations, and any other arbitrary group. The group may also be more specific subgroups, such as company departments (sales, general affairs, and customer support).

The group table 1013 is a table having columns of group ID, group name, and group attribute with the group ID as the primary key.

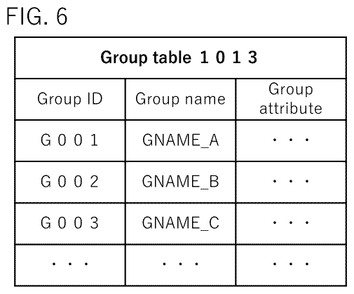

FIG. 6 shows a data structure of the group table 1013.

The group ID is an item for storing group identification information for identifying the group. The group identification information is an item of a unique value set for each piece of group information.

The group name is an item for storing the name of the group. The group name can be any character string.

The group attribute is an item for storing information on group attributes such as group types (company, corporate group, other organization, etc.) and business types (real estate, finance, etc.).

The dialog table 1014 is a table for storing and managing information (dialog information) on dialogs performed between users and customers.

The dialog table 1014 is a table having columns of dialog ID, user ID, customer ID, dialog category, incoming/outgoing call type, voice data, and video data, with the dialog ID as the primary key.

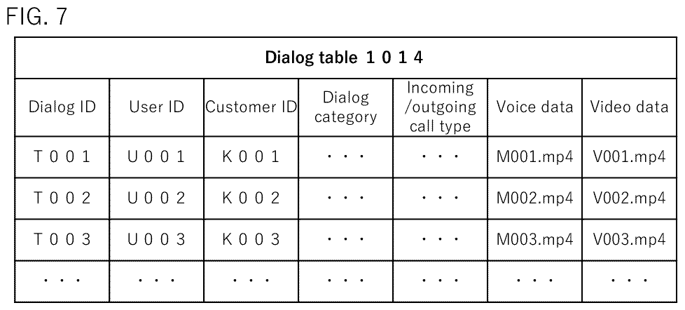

FIG. 7 shows a data structure of the dialog table 1014.

The dialog ID is an item for storing dialog identification information for identifying the dialog. The dialog identification information is an item of a unique value set for each piece of dialog information.

The user ID is an item for storing user identification information for identifying the user in the dialog performed between the user and the customer. A plurality of user IDs may be associated with each piece of dialog information.

The customer ID is an item for storing user identification information for identifying the customer in the dialog performed between the user and the customer. The user IDs of a plurality of customers may be associated with each piece of dialog information.

The dialog category is an item for storing the type (category) of the dialog performed between the user and the customer. The dialog data is classified by dialog category. In the dialog category, values of telephone user, telemarketing, customer support, technical support, and the like are stored in accordance with the purpose of the dialog between the user and the customer.

The incoming/outgoing call type is an item for storing information for distinguishing whether the dialog performed between the user and the customer is initiated by the user (outbound) or received by the user (inbound). In addition, in the case of a dialog among three or more users, the incoming/outgoing call type “room” is stored.

The voice data is an item for storing voice data collected by a microphone. Reference information (path) to a voice data file located at another location may be stored. The format of the voice data may be any data format such as AAC, ATRAC, mp3, and mp4.

The voice data may be data in a format in which identifiers that can independently identify the voice of the user and the voice of the customer are set. In this case, the control unit 104 of the server 10 can perform independent analysis processing for the voice of the user and the voice of the customer. In addition, the user ID and the customer ID can be identified based on the voice data of the user and the voice data of the customer.

In the present disclosure, video data including voice information may be used in place of voice data. In addition, the voice data in the present disclosure includes voice data included in video data. In addition, data in other data formats associated with various types of data may also be stored. For example, data such as contract documents, meeting minutes, presentation files, or emails may be included.

The video data is an item for storing video data captured by a camera or the like. Reference information (path) to a video data file located at another location may be stored. The format of the video data may be any data format such as MP4, MOV, WMV, AVI, or AVCHD.

The video data may be data in a format in which identifiers that can independently identify the video of the user and the video of the customer are set. In this case, the control unit 104 of the server 10 can perform independent analysis processing for the video of the user and the video of the customer. In addition, the user ID and the customer ID can be identified based on the video data of the user and the video data of the customer.

The label table 1015 is a table for storing and managing information (label information) on labels.

The label table 1015 includes columns of dialog ID and label data.

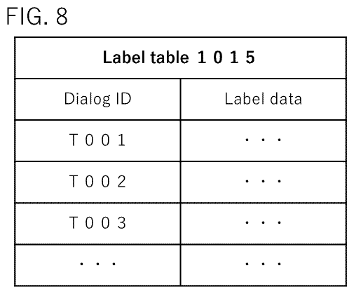

FIG. 8 shows a data structure of the label table 1015.

The dialog ID is an item for storing dialog identification information for identifying the dialog.

The label data is an item for storing label information for managing the dialog. The label information is additional information for managing dialog information, such as a classification name, a label, a classification label, or a tag.

The label data may be a character string indicating the name of the label information, a label ID for referring to the name of the label information stored in another table, or the like.

The label data includes classification information according to the emotional state of the speaker in a specific dialog. The classification data includes classification information for classifying whether the response of the speaker in a specific dialog is good or bad.

The voice segment table 1016 is a table for storing and managing information (voice segment information) on a plurality of voice segments included in dialog information.

The voice segment table 1016 is a table having columns of segment ID, dialog ID, speaker ID, start date and time, end date and time, segment voice data, segment video data, and segment reading aloud text, with the segment ID as the primary key.

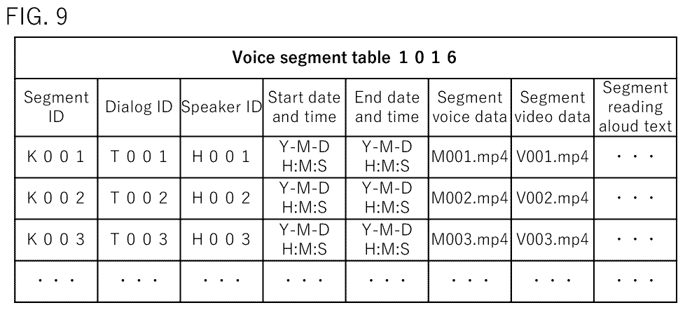

FIG. 9 shows a data structure of the voice segment table 1016.

The segment ID is an item for storing segment identification information for identifying a voice segment. The segment identification information is an item of a unique value set for each piece of voice segment information.

The dialog ID is an item for storing dialog identification information for identifying the dialog associated with voice segment information.

The speaker ID is an item for storing speaker identification information for identifying the speaker associated with voice segment information. Specifically, the speaker ID is an item for storing a plurality of user IDs and customer IDs participating in the dialog.

The start date and time is an item for storing the start date and time of the voice segment and the video segment.

The end date and time is an item for storing the end date and time of the voice segment and the video segment.

The segment voice data is an item for storing voice data included in the voice segment. Reference information (path) to a voice data file located at another location may be stored. It is also possible to store a reference to the voice data from the start date and time to the end date and time of the voice data in the dialog table 1014, based on the start date and time and the end date and time. In addition, the segment voice data may include voice data included in the segment video data.

The format of the voice data may be any data format such as AAC, ATRAC, mp3, and mp4, or may include a plurality of types of data formats.

The segment video data is an item for storing video data included in the voice segment. Reference information (path) to a video data file located at another location may be stored. It is also possible to store a reference to the video data from the start date and time to the end date and time of the video data of the dialog table 1014, based on the start date and time and the end date and time.

The format of the video data may be any data format such as MP4, MOV, WMV, AVI, AVCHD, or may include a plurality of types of data formats.

The segment reading aloud text is an item for storing text information of the content spoken by the speaker in the segment voice data included in the voice segment. Specifically, the segment reading aloud text may be generated, based on the segment voice data or the segment video data, manually or using any learning model such as machine learning or deep learning.

The comment table 1021 is a table for storing and managing information (response information) on responses.

The comment table 1021 is a table having columns of directive, analysis data, input data, and comment data.

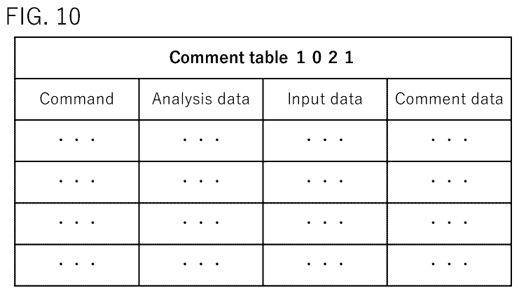

FIG. 10 shows a data structure of the comment table 1021.

The directive is an item for storing a character string related to a directive for generating input data. Specifically, the directive is input and edited in accordance with an input operation by the user, or an input directive is stored by the user selecting a predetermined input candidate.

The analysis data is an item for storing information (analysis information) obtained by analyzing the dialog information, the voice segment information, or the like. The analysis data specifically includes the following information.

### Voice Feature Relating to the Voice Uttered by the Speaker

Specifically, the voice feature includes the ratio of the speech of the user to the speech of the callee (Talk: Listen ratio), the number of times overlap occurred between the speech of the user and the speech of the callee (overlap count), the number of times silence occurred (silence count), the frequency of the speech of the user or the speech of the callee (fundamental frequency of the user, fundamental frequency of the callee), and the intonation of the speech of the user or the speech of the callee (intonation strength of the user, intonation strength of the callee).

It should be noted that the analysis data includes pitch (fundamental frequency), voice intensity (volume), spectral characteristics (including frequency domain characteristics of uttered voice, voiceprint, timbre, and the like), voice speed of uttered voice, voice length of individual syllables, words, phrases, and the like, voice rhythm, voice quality (clear voice, hoarse voice, and the like), and the like in the speech of both the user and the callee.

### Language Feature Relating to the Content of the Speech

Specifically, the language feature includes the number of occurrences and frequency of a predetermined keyword included in the dialog, an index relating to the diversity of words, the length of the spoken sentence, an index indicating the frequency of use of a part of speech such as a noun, a verb, and an adjective, the use of emotional words, and information on the distribution of topics.

### Number of Calls and Call Duration Relating to the Dialog

The number of calls includes the number of calls in a specific period of time (day, week, month, etc.). The call duration is an index indicating how long each call lasted.

The analysis data includes a statistical value such as an average value, a median value, a maximum value, or a minimum value based on analysis data including the above-described features in a plurality of dialogs for each user or group. The analysis data includes a comparison result such as a ranking, a position or the like of the analysis data including the above features, for each user or group. The statistical value and the comparison result based on the analysis data may be calculated based on a predetermined rule.

The input data is an item for storing input data called a prompt to be input to the generative AI 50.

The comment data is an item for storing data on a comment message (message document) mainly notified to the user, which is created based on response data (response) obtained in response to input of input data to the generative AI 50.

### Configuration of Control Unit 104 of Server 10

The control unit 104 of the server 10 includes a user registration control unit 1041 and a presentation unit 1042. The control unit 104 implements each functional unit by executing the application program 1011 stored in the storage unit 101.

The user registration control unit 1041 performs processing for storing information on the user who desires to use the service according to the present disclosure in the user table 1012.

The information stored in the user table 1012 is transmitted to the server 10 by the user opening a web page operated by a service provider and inputting information in a predetermined input form through any information processing terminal. The user registration control unit 1041 stores the received information in a new record of the user table 1012, completing the user registration. Thus, the user stored in the user table 1012 can use the service.

Prior to the registration of the user information in the user table 1012 by the user registration control unit 1041, the service provider may conduct a predetermined review and restrict the user's ability to use the service.

The user ID may be any character string or numeral capable of identifying the user, and may be any character string or numeral desired by the user, or may be any character string or numeral automatically set by the user registration control unit 1041.

The presentation unit 1042 executes presentation processing. Details will be described later.

### Configuration of First User Terminal 20

The first user terminal 20 is an information processing apparatus operated by the user who uses the service. The first user terminal 20 may be, for example, a stationary personal computer (PC) or a laptop PC, or a portable terminal such as a smartphone or a tablet. Further, it may be a head mount display (HMD), or a wearable terminal such as a wristwatch type terminal.

The first user terminal 20 includes a storage unit 201, a control unit 204, an input apparatus 206, and an output apparatus 208.

### Configuration of Storage Unit 201 of First User Terminal 20

The storage unit 201 of the first user terminal 20 includes a first user ID 2011 and an application program 2012.

As the first user ID 2011, user identification information of the operator is stored. The operator transmits the first user ID 2011 from the first user terminal 20 to the voice server (PBX) 60. The voice server (PBX) 60 identifies the operator based on the first user ID 2011, and provides the service according to the present disclosure to the operator. It should be noted that the first user ID 2011 includes information on a session ID or the like temporarily assigned by the voice server (PBX) 60 for identifying the operator using the first user terminal 20.

The application program 2012 may be stored in the storage unit 201 in advance, or may be downloaded, via a communication IF, from a web server or the like operated by a service provider.

The application program 2012 includes applications, such as a web browser application.

The application program 2012 includes an interpreted programming language such as JavaScript (registered trademark) executed on a web browser application stored in the first user terminal 20.

### Configuration of Control Unit 204 of First User Terminal 20

The control unit 204 of the first user terminal 20 includes an input control unit 2041 and an output control unit 2042. The control unit 204 implements each functional unit by executing the application program 2012 stored in the storage unit 201.

### Configuration of Input Apparatus 206 of First User Terminal 20

The input apparatus 206 of the first user terminal 20 includes a camera 2061, a microphone 2062, a position information sensor 2063, a motion sensor 2064, and a keyboard 2065.

### Configuration of Output Apparatus 208 of First User Terminal 20

The output apparatus 208 of the first user terminal 20 includes a display 2081 and a speaker 2082.

### Configuration of Second User Terminal 30

The second user terminal 30 is an information processing apparatus operated by the customer who uses the service. The second user terminal 30 may be, for example, a portable terminal such as a smartphone or a tablet, or may be a stationary personal computer (PC) or a laptop PC. Further, it may be a head mount display (HMD), or a wearable terminal such as a wristwatch type terminal.

The second user terminal 30 includes a storage unit 301, a control unit 304, an input apparatus 306, and an output apparatus 308.

### Configuration of Storage Unit 301 of Second User Terminal 30

The storage unit 301 of the second user terminal 30 includes an application program 3012 and a telephone number 3013.

The application program 3012 may be stored in the storage unit 301 in advance, or may be downloaded, via a communication IF, from a web server operated by a service provider.

The application program 3012 includes applications, such as a web browser application.

The application program 3012 includes an interpreted programming language such as JavaScript (registered trademark) executed on a web browser application stored in the second user terminal 30.

### Configuration of Control Unit 304 of Second User Terminal 30

The control unit 304 of the second user terminal 30 includes an input control unit 3041 and an output control unit 3042. The control unit 304 implements each functional unit by executing the application program 3012 stored in the storage unit 301.

### Configuration of Input Apparatus 306 of Second User Terminal 30

The input apparatus 306 of the second user terminal 30 includes a camera 3061, a microphone 3062, a position information sensor 3063, a motion sensor 3064, and a touch apparatus 3065.

### Configuration of Output Apparatus 308 of Second User Terminal 30

The output apparatus 308 of the second user terminal 30 includes a display 3081, a speaker 3082, and a transmission unit 6041.

The transmission unit 6041 is a control unit that executes processing for transmitting evaluation data received at an external server 60 from the user to the server 10.

### Configuration of Voice Server (PBX) 50

The voice server (PBX) 50 is an information processing apparatus that connects the network N and the telephone network T to each other to function as a switchboard that enables a dialog between the first user terminal 20 and the second user terminal 30.

The voice server (PBX) 50 includes a storage unit 501.

### Configuration of Storage Unit 501 of Voice Server (PBX) 50

The storage unit 501 of the voice server (PBX) 50 includes an application program 5011.

The application program 5011 is a program for causing the control unit 504 of the voice server (PBX) 50 to function as each functional unit.

The application program 5011 includes applications, such as a web browser application.

### Configuration of Generative AI 80

The generative AI 80 is a kind of artificial intelligence model (deep learning model) that outputs output data such as a character string or an image based on input data such as a character string or an image. In the present disclosure, a large language model (LLM) that outputs output data relating to a character string based on input data relating to a character string will be mainly described as an example. The LLM includes, for example, OpenAI ChatGPT, Microsoft BingChat, and Google Bard.

### Operation of System 1

Hereinafter, each process of the system 1 will be described.

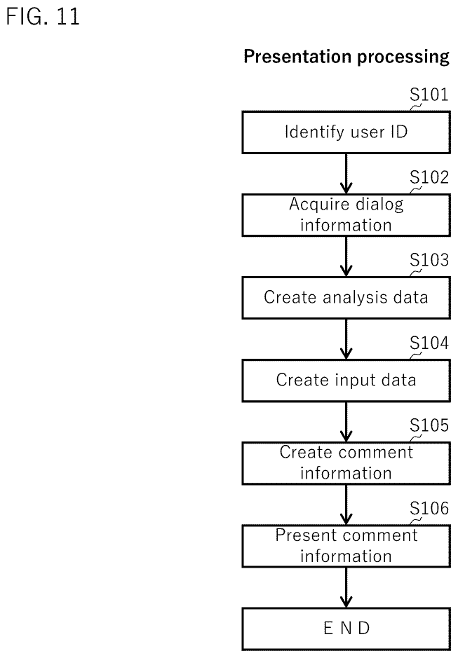

FIG. 11 is a flowchart showing an operation of comment processing.

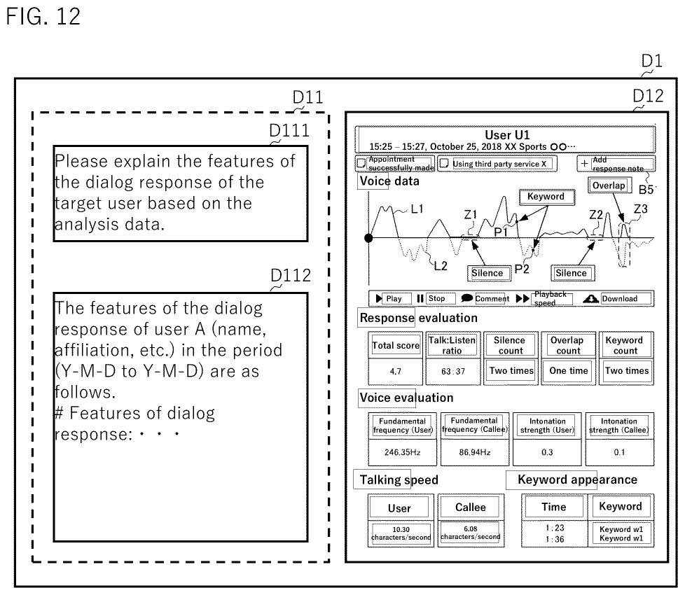

FIG. 12 is a screen example showing the operation of the comment processing.

### Dialog Processing

Processing for enabling the first user and the second user to have a dialog by incoming call processing in which the first user (operator) receives an incoming call from the second user (customer) or outgoing call processing in which the first user (operator) makes an outgoing call to the second user (customer) will be described below.

The method for enabling the first user and the second user to have a dialog is not limited thereto. For example, the processing in which the first user has a dialog with the second user includes processing in which a plurality of users have a dialog in a virtual dialog space called a room, which will be described as room dialog processing.

The disclosure according to the present disclosure can be applied to methods in which the first user and the second user are enabled to have a dialog by the incoming call processing, the outgoing call processing, or any other method.

### Room Dialog Processing

There is a method in which a virtual dialog space called a room for a dialog between the first user and the second user is created on the server 10, and the first user and the second user access the room via web browsers or application programs stored in the first user terminal 20 and the second user terminal 30 to be able to have a dialog. In this case, the voice server (PBX) 60 is unnecessary.

Specifically, the first user serving as the host of the dialog operates the input apparatus 206 of the first user terminal 20 to transmit a request for holding a dialog to the server 10. Upon receiving the request, the control unit 104 of the server 10 issues room identification information such as a unique room ID and transmits a response to the first user terminal 20. The first user transmits the received room identification information to the second user, who is a dialog partner, by any communication means such as email or chat. The first user can enter the room by operating the input apparatus 206 of the first user terminal 20, accessing the URL providing the room-related service of the server 10 with a web browser or the like, and inputting the room identification information. Similarly, the second user can enter the room by operating the input apparatus 306 of the second user terminal 30, accessing the URL providing the room-related service of the server 10 with a web browser or the like, and inputting the room identification information. The first user and the second user can thereby have a dialog via the first user terminal 20 and the second user terminal 30, respectively, in a virtual dialog space called a room associated with them by the room identification information.

By inputting the room identification information, in addition to the first user and the second user, one or more other users can enter one room. Thus, three or more users can have a dialog via their respective user terminals in a virtual dialog space called a room which is associated with them by the room identification information.

In addition, it is not always necessary to have a configuration in which the dialog processing is executed by all participants participating in the room. For example, in a conference held in a conference room or the like in which a plurality of participants participate, a plurality of participants may enter a room via one information terminal and the dialog processing may be executed. The dialog processing is not necessarily executed online, but may be executed on a conference held in a conference room or the like in which a plurality of participants participate, using an information terminal that acquires video and voice of the conference content. For example, the dialog processing may be executed in an application for facilitating the conference.

### Video Dialog

The system 1 in the present disclosure may provide an online dialog service (video dialog service) including video data. For example, the control unit 204 of the first user terminal 20 and the control unit 304 of the second user terminal 30 transmit video data captured by the camera 2061 of the first user terminal 20 and video data captured by the camera 3061 of the second user terminal 30 to the server 10, respectively.

Based on the received video data, the server 10 transmits the video data captured by the camera 2061 of the first user terminal 20 to the second user terminal 30, and transmits the video data captured by the camera 3061 of the second user terminal 30 to the first user terminal 20. The control unit 204 of the first user terminal 20 causes the display 2081 to display the received video data captured by the camera 3061 of the second user terminal 30. The control unit 304 of the second user terminal 30 causes the display 3081 to display the received video data captured by the camera 2061 of the first user terminal 20.

The server 10 may transmit the video data of some or all of the users participating in the online dialog to the first user terminal 20 and the second user terminal 30. In this case, the control unit 204 of the first user terminal 20 causes the display 2081 of the first user terminal 20 to display the received video data of some or all of the users participating in the online dialog side-by-side on a single screen. In this way, it is possible to check the dialog statuses of a plurality of users participating in the online dialog. The same processing may be executed at the second user terminal 30.

In the outgoing call processing and the room dialog processing, when a dialog is started between the user and the customer, dialog storing processing is executed in the same manner as in the incoming call processing. Since the dialog storing processing is the same as step S104 of the incoming call processing, the description thereof will be omitted.

The room dialog processing may be executed by an online meeting service or the like managed by a business operator different from that of the information processing service according to the present disclosure. The online meeting service includes Zoom, Google Meet, Microsoft Teams, etc.

### Incoming Call Processing

The incoming call processing is processing for the user to receive an incoming call from the customer.

### Outline of Incoming Call Processing

The incoming call processing is a series of processes of, when a customer makes an outgoing call to a user who has launched an application on the first user terminal 20, identifying a response rule to be applied to the customer, executing an incoming call determination process based on the identified response rule, and executing a process of connecting to the user in accordance with the determination result.

It should be noted that, in the present disclosure, the incoming call processing using telephone is described as an example, but the present disclosure is also applicable to incoming call processing using any online dialog service and the like.

### Details of Incoming Call Processing

Incoming call processing of the system 1 when the user receives an incoming call from the customer will be described.

When the user receives an incoming call from the customer, the following processing is executed in the system 1.

In step S101, the user operates the first user terminal 20 to start the web browser and accesses the CRM service web site provided by the CRM system 50. At this time, it is assumed that the user has logged in to the CRM system 50 using their own account on the web browser and is on standby. It should be noted that the user only needs to be logged in to the CRM system 50 and may be performing other tasks related to the CRM service.

In step S102, the customer operates the second user terminal 30 to input a predetermined telephone number assigned to the voice server (PBX) 60, and makes an outgoing call to the voice server (PBX) 60. The voice server (PBX) 60 receives the outgoing call from the second user terminal 30 as an incoming event.

The voice server (PBX) 60 transmits an incoming call event to the server 10. Specifically, the voice server (PBX) 60 transmits an incoming call request including the telephone number 3011 of the customer to the server 10.

In step S103, the first user terminal 20 receives a response operation from the user. The response operation is realized, for example, by lifting a receiver (not shown) on the first user terminal 20, or by the user pressing a button indicating “Answer the call” on the display 2081 of the first user terminal 20 by operating the mouse 2066.

Upon receiving the response operation, the first user terminal 20 transmits a response request to the voice server (PBX) 60 via the CRM system 50 and the server 10. The voice server (PBX) 60 receives the transmitted response request and establishes voice communication. The first user terminal 20 is thereby enabled to have a dialog with the second user terminal 30.

The display 2081 of the first user terminal 20 displays information indicating that a dialog is being performed. For example, the display 2081 of the first user terminal 20 may display a character string of “in conversation”.

### Dialog Storing Processing

In step S104, the dialog storing processing is executed. The dialog storing processing is processing for storing data relating to a dialog performed between the user and the customer.

### Outline of Dialog Storing Processing

The dialog storing processing is a series of processes of, when a dialog starts between the user and the customer, storing data relating to the dialog in the dialog table 1014.

### Details of Dialog Storing Processing

In step S104, the control unit 104 of the server 10 executes a voice acquisition step of acquiring voice data relating to the dialog.

Specifically, when a dialog between the user and the customer starts, the voice server (PBX) 60 records voice data relating to the dialog performed between the user and the customer, and transmits the voice data to the server 10. Upon receiving the voice data, the control unit 104 of the server 10 creates a new record in the dialog table 1014, and stores data relating to the dialog performed between the user and the customer. Specifically, the control unit 104 of the server 10 stores the user ID, the customer ID, the dialog category, the incoming/outgoing call type, and the content of the voice data in a new record of the dialog table 1014.

In the outgoing call processing or the incoming call processing, the control unit 104 of the server 10 acquires the first user ID 2011 of the user from the first user terminal 20, and stores it in the item of the user ID of the new record of the dialog table 1014.

In the outgoing call processing or the incoming call processing, the control unit 104 of the server 10 makes an inquiry to the CRM system 50 based on the telephone number. The CRM system 50 retrieves the customer ID by searching the customer table 5012 using the telephone number, and transmits it to the server 10. The control unit 104 of the server 10 stores the acquired customer ID in the item of the customer ID of a new record of the dialog table 1014.

The control unit 104 of the server 10 stores the value of the dialog category set in advance for each user or customer in the item of the dialog category of the new record of the dialog table 1014. It should be noted that the dialog category may be stored by the user selecting and inputting a value for each dialog.

The control unit 104 of the server 10 identifies whether the dialog being performed is initiated by the user or initiated by the customer, and stores a value of either outbound (initiated by the user) or inbound (initiated by the customer) in the item of the incoming/outgoing call type of the new record of the dialog table 1014.

The control unit 104 of the server 10 stores the voice data received from the voice server (PBX) 60 in the item of the voice data of the new record of the dialog table 1014. It should be noted that the voice data may be stored as a voice data file at another location, and reference information (path) for the voice data file may be stored after the dialog is completed. Further, the control unit 104 of the server 10 may be configured to store the voice data after the dialog is completed.

Also, in the video dialogue service, the control unit 104 of the server 10 stores the video data received from the first user terminal 20 and the second user terminal 30 in the item of the video data of a new record of the dialog table 1014. The video data may be stored as a video data file at another location, and reference information (path) for the video data file may be stored after the dialog is completed. Further, the control unit 104 of the server 10 may be configured to store the video data after the dialog is completed.

The control unit 104 of the server 10 executes a voice extraction step of extracting, from the voice data acquired in the voice acquisition step, a plurality of segment voice data for each speech segment. The voice extraction step includes a step of identifying a speaker for each of the plurality of segment voice data.

Specifically, the control unit 104 of the server 10 acquires (receives) the dialog ID, the voice data, and the video data stored in the dialog table 1014. The control unit 104 of the server 10 detects segments (speech segments) in which uttered voice continuously exist from the acquired (received) voice data and video data, and extracts the voice data and the video data for each of the speech segments as segment voice data and segment video data, respectively. For example, segment voice data and segment video data may be extracted by dividing voice data and video data using silent segments in which no uttered voice exists. It is also possible to extract segment voice data and segment video data by dividing voice data and video data into linguistic units such as segments, sentences, or paragraphs with respect to the speech content included in the voice data and the video data. The segment voice data and the segment video data are associated with the user ID of the speaker, the start date and time of the speech segment, and the end date and time of the speech segment for each speech segment.

The control unit 104 of the server 10 executes a text generation step of generating a plurality of segment reading aloud texts, which are text information of the content spoken by the speaker, for each of the plurality of segment voice data extracted in the voice extraction step.

Specifically, the control unit 104 of the server 10 performs text recognition on the speech content of the extracted segment voice data and segment video data, thereby converting the segment voice data and segment video data into reading aloud text which is a character (text) for transcription. It should be noted that the specific method of text recognition is not particularly limited. For example, the conversion may be performed by machine learning or deep learning using a signal processing technique or artificial intelligence (AI).

The control unit 104 of the server 10 stores the processing target dialog ID, the user ID of the speaker (first user ID 2011 or second user ID 3011), the start date and time, the end date and time, the segment voice data, the segment video data, and the segment reading aloud text in the items of the dialog ID, the speaker ID, the start date and time, the end date and time, the segment voice data, the segment video data, and the segment reading aloud text of a new record of the voice segment table 1016.

The voice segment table 1016 stores, as continuous time-series data, a segment reading aloud text for each speech segment of voice data in association with the start date and time and the speaker. By confirming the segment reading aloud text stored in the voice segment table 1016, the user can check the content of the dialog as text information without checking the content of the voice data.

It should be noted that, at the time of text recognition processing, it is also possible to exclude, from the text, meaningless information for grasping the dialog performed between the user and the customer, such as a filler included in the text in advance, and store voice recognition information in the voice segment table 1016.

### Outgoing Call Processing

The outgoing call processing is processing for making an outgoing call from the user (first user) to the customer (second user).

### Outline of Outgoing Call Processing

The outgoing call processing is a series of processes in which the user selects a customer to whom the user desires to make an outgoing call among a plurality of customers displayed on the screen of the first user terminal 20, and performs an outgoing call operation to make an outgoing call to the customer. In the present disclosure, a case where the second user is selected as the customer will be described as an example.

### Details of Outgoing Call Processing

The outgoing call processing of the system 1 in a case where an outgoing call is made from the user to the customer will be described.

When the user makes an outgoing call to the customer, the following processing is executed in the system 1.

The user operates the first user terminal 20 to start the web browser and access the CRM service web site provided by the CRM system 50. The user can have a list of their customers displayed on the display 2081 of the first user terminal 20 by opening a customer management screen provided by the CRM service.

Specifically, the first user terminal 20 transmits a CRM ID 2013 and a request to display a list of customers to the CRM system 50. Upon receiving the request, the CRM system 50 searches the customer table 5012, and transmits information on the customer of the user, such as a customer ID, a name, a telephone number, a customer attribute, a customer organization name, and a customer organization attribute, to the first user terminal 20. The first user terminal 20 causes the display 2081 of the first user terminal 20 to display the received information on the customer.

The user selects a customer (second user) they wish to call from among customers listed on the display 2081 of the first user terminal 20 by pressing the customer. When the customer presses the “call” button or the telephone number button displayed on the display 2081 of the first user terminal 20 with the customer selected, a request including the telephone number is transmitted to the CRM system 50. The CRM system 50 having received the request transmits the request including the telephone number to the server 10. Upon receiving the request, the server 10 transmits an outgoing call request to the voice server (PBX) 60. Upon receiving the outgoing call request, the voice server (PBX) 60 makes an outgoing call (call) to the second user terminal 30 based on the received telephone number.

Consequently, the first user terminal 20 controls the speaker 2082 or the like to emit a ringing tone indicating that the voice server (PBX) 60 is making an outgoing call (call). The display 2081 of the first user terminal 20 displays information indicating that the voice server (PBX) 60 is making an outgoing call (call) to the customer. For example, the display 2081 of the first user terminal 20 may display a character string of “calling”.

The customer lifts a receiver (not shown) on the second user terminal 30 or presses a “receive” button or the like displayed at the time of receiving an incoming call on the input apparatus 306 of the second user terminal 30, whereby the second user terminal 30 is enabled to have a dialog. Consequently, the voice server (PBX) 60 transmits information indicating that the second user terminal 30 has responded (hereinafter referred to as a “response event”) to the first user terminal 20 via the server 10, the CRM system 50, and the like.

As a result, the user and the customer are enabled to have a dialog using the first user terminal 20 and the second user terminal 30, respectively. Specifically, the voice of the user collected by the microphone 2062 of the first user terminal 20 is output from the speaker 3082 of the second user terminal 30. Similarly, the voice of the customer collected from the microphone 3062 of the second user terminal 30 is output from the speaker 2082 of the first user terminal 20.

When the first user terminal 20 is enabled to have a dialog, the display 2081 of the first user terminal 20 displays information indicating that the first user terminal 20 has received a response event and is having a dialog. For example, the display 2081 of the first user terminal 20 may display a character string of “responding”.

### Presentation Processing

The presentation processing is processing for presenting voice features including dialog summary information that summarizes the features of the dialog response of the user and advice for improving the dialog response based on the past dialog information of the user or the group to which the user belongs.

By checking the content of comment information, the user, such as an operator, can utilize it to improve their own dialog responses. A user in a position to manage a group composed of a plurality of operators, such as executives, can utilize the content of the comment information to improve the dialog responses of the group managed by the user.

### Outline of Presentation Processing

The presentation processing is a series of processes of identifying a target user of the presentation processing, acquiring dialog information of the user, creating analysis data based on the dialog information, creating input data based on the analysis data, creating comment information based on a response result obtained by transmitting the input data to a generative AI, and presenting the created comment information.

### Details of Presentation Processing

Details of the presentation processing will be described below.

In the present disclosure, although a configuration in which the first user executes the presentation processing is disclosed as an example, the presentation processing may be executable by any user. Alternatively, the presentation processing may be executable only by a user who is engaged in management work, such as a manager. The execution authority of the presentation processing may be set to any user, or the executable processing may be switched for each execution authority of the user.

Further, in the present disclosure, a configuration in which the presentation processing is executed based on an operation by the first user is disclosed as an example, but the configuration is not limited thereto. For example, the user ID to be subjected to the presentation processing in step S101 to be described later may be identified and the user to whom the comment information is to be distributed may be stored in advance in association with the identified target user or target group. In this case, the presentation unit 1042 of the server 10 may periodically distribute the comment message based on the comment information on the target user or the target group created by executing the presentation processing periodically (every day, every week, every month) to the user as the distribution destination. It should be noted that, when the comment information is presented to the user, it may be possible to enable the user to designate the target period and target range.

In step S101, the presentation unit 1042 of the server 10 identifies a user ID (target user ID) to be subjected to the presentation processing.

The first user operates the input apparatus 206 of the first user terminal 20 to input the URL of the page (presentation processing page) for executing the presentation processing into the web browser or the like, thereby opening the presentation processing page. The control unit 204 of the first user terminal 20 transmits a request for opening the presentation processing page to the server 10. Based on the received request, the control unit 104 of the server 10 generates a presentation processing page and transmits it to the first user terminal 20. The control unit 204 of the first user terminal 20 causes the display 2081 of the first user terminal 20 to display the received presentation processing page.

The first user operates the input apparatus 206 of the first user terminal 20 to input the user ID, the user name, and the like of the user to be the target of the presentation processing in the input field for inputting the target user ID included in the presentation processing page. It should be noted that the presenting processing page may display a list of user identification information, such as user IDs and user names, stored in the user table 1012 for the first user, and receive input of a target user ID in accordance with a selection operation on the user identification information displayed in the list. The control unit 204 of the first user terminal 20 transmits the input target user ID to the server 10. The presentation unit 1042 of the server 10 receives and identifies the target user ID.

The presentation processing page may be configured to receive input of a plurality of user IDs and the like. For example, the presentation processing page displays a list of group identification information, such as group IDs and group names, stored in the group table 1013 for the first user, and receives input of a group ID (the group ID of the target group) in accordance with a selection operation on the group identification information displayed in the list. The control unit 204 of the first user terminal 20 transmits the input group ID to the server 10. The presentation unit 1042 of the server 10 searches the item of group IDs of the user table 1012 based on the received group ID, and identifies the user IDs of one or more users belonging to the selected group.

In step S102, the control unit 104 of the server 10 acquires dialog information based on one or more target user IDs identified in step S101 (hereinafter referred to as target user IDs).

Specifically, the presentation unit 1042 of the server 10 searches the item of user IDs of the dialog table 1014 based on the identified target user ID, and acquires one or more pieces of dialog information.

Specifically, the dialog information includes a dialog ID, a user ID, a customer ID, a dialog category, an incoming/outgoing call type, voice data, and video data.

Based on the dialog ID included in the acquired dialog information, the presentation unit 1042 of the server 10 searches the item of dialog IDs of the label table 1015 to acquire one or more label information.

The presentation unit 1042 of the server 10 searches the item of dialog IDs of the voice segment table 1016 based on the dialog ID included in the acquired dialog information, and acquires one or more voice segment information. The voice segment information includes a segment ID, a dialog ID, a speaker ID, a start date and time, an end date and time, segment voice data, segment video data, and segment reading aloud text.

The dialog information in the present disclosure may include information relating to an arbitrary dialog in addition to label information and voice segment information associated with predetermined dialog information based on the dialog ID.

In step S103, the presentation unit 1042 of the server 10 executes an analysis data acquisition step of acquiring analysis data obtained by analyzing a dialog.

Specifically, the presentation unit 1042 of the server 10 creates analysis data including the following voice features and language features by analyzing voice data, video data, and the like included in the dialog information acquired in step S102, and segment voice data, segment video data, and the like included in the voice segment information. The presentation unit 1042 of the server 10 analyzes the number of records of the dialog information, voice data, video data, and the like to create analysis information including dialog-related indices, such as the number of calls made and call duration. It should be noted that the present disclosure is not limited to the case where analysis data is created in this step, and analysis data created in advance may be included in the target of this step.

### Voice Features Relating to the Voice Uttered by the Speaker

The voice features include a ratio between the operator's speech and the customer's speech (Talk: Listen ratio), the number of times overlap occurred between the operator's speech and the customer's speech (overlap count), the number of times of silence occurred (silence count), the frequency of the operator's speech or the customer's speech (operator's fundamental frequency, customer's fundamental frequency), the intonation of the operator's speech or the customer's speech (intonation strength of the operator, intonation strength of the customer), and the like.

The voice features include pitch (fundamental frequency), voice intensity (volume), spectral characteristics (including frequency domain characteristics of uttered voice, voiceprint, timbre, and the like), voice speed of uttered voice, the length of voice of individual syllables, words, phrases, and the like, rhythm of voice, voice quality (clear voice, hoarse voice, and the like), and the like in the speech of both the operator and the customer.

The speech features include score information (voice score) indicating the voice feature quality, which is calculated based on the above voice features.

### Language Features Relating to the Spoken Content

The language features include the number of occurrences and frequency of a predetermined keyword included in the dialog, an index relating to the diversity of words, the length of the spoken sentence, an index indicating the frequency of use of a part of speech such as a noun, a verb, and an adjective, the use of emotional words, and information on the distribution of topics.

The language features include score information (language score) indicating the language feature quality, which is calculated based on the above language features.

### Dialog-Related Indices Such as the Number of Calls and Call Duration

The number of calls includes the number of calls in a specific period of time (day, week, month, etc.). The call duration is an index indicating how long each call lasted.

The dialog-related indices include score information (index score) indicating the dialog-related index quality, which is calculated based on the above dialog-related indices.

In addition, they may include dialog score information (dialog score) comprehensively indicating the dialog response quality obtained by combining the voice score, the language score, and the index score.

It should be noted that the analysis data may be statistical values such as an average value, a median value, a maximum value, and a minimum value of analysis data (hereinafter referred to as features or the like) including the voice features, language features, and indices in a plurality of dialogs for each user or group. Specifically, when a plurality of users are identified in step S101, the statistical values of the speech features, the language features, and the indices relating to the dialog of the plurality of users may be used as the analysis data.

The analysis data includes a comparison result such as a ranking, a position or the like of the analysis data including features and the like, for each user or group. Specifically, when user A has a voice score of 1st place, a language score of 2nd place, an index score of 4th place, and a dialogue score of 2nd place, user A's comparison result shall be expressed as (1, 2, 4, 2). In this case, the comparison results of user B, user C, and user D can be (2, 1, 3, 4), (4, 3, 1, 2), and (3, 4, 2, 1), respectively. The comparison result includes information for comparing the qualities of analysis data among a plurality of users. In addition, the analysis data may include a comparison over a predetermined period of time. For example, by including a monthly comparison value such as an average value, it can be used as an index of the degree of improvement.

The analysis data may include information on the reading aloud text in a plurality of dialogs for each user or group. Specifically, the reading aloud text associated with the dialog can be included in the analysis data by referring to the segment reading aloud text in the voice segment table 1016.

In step S103, as the analysis data acquisition step, a step of acquiring analysis data obtained by analyzing a dialog performed by a predetermined operator is executed.

Specifically, when a user ID of the user of a predetermined operator is identified as the target user ID in step S101, the presentation unit 1042 of the server 10 creates and acquires analysis data of the predetermined operator.

In step S103, as the analysis data acquisition step, a step of acquiring analysis data on each of the plurality of operators obtained by analyzing a plurality of dialogs performed by the plurality of operators is executed.

Specifically, when the user IDs of the users of the plurality of operators are identified as the target user IDs in step S101, the presentation unit 1042 of the server 10 creates and acquires analysis data of the plurality of operators.

In step S103, as the analysis data acquisition step, a step of acquiring analysis data in a predetermined period of time is executed.

Specifically, based on dialog information within a predetermined period of time from a date and time when the presentation processing is executed or an arbitrary date and time, the presentation unit 1042 of the server 10 may create and acquire analysis data by excluding dialog information outside the predetermined period of time. For example, the presentation unit 1042 of the server 10 may create and acquire analysis data based on the dialog information within the most recent month.

This is because providing comment information based on the most recent dialog information is considered to be useful for improving user's dialog response.

The presentation unit 1042 of the server 10 stores the created analysis data in the item of analysis data of a new record (target record) of the comment table 1021.

A character string relating to a directive for generating input data to be described later is stored in the item of directives of the target record of the comment table 1021. Examples of the directive are given below.
“Please explain the features of the dialog response of the target user based on the analysis data.”
“Please explain the features showing change in the dialog response of the target user based on the analysis data.”
“Please explain the goal achievement status of the dialog response of the target user based on the analysis data.”
“Please explain the improvement point of the dialog response of the target user based on the analysis data.”
“Please suggest another user who will be helpful for the dialog response of the target user based on the analysis data.”
“Please explain the features of the dialog response of the target group based on the analysis data.”
“Please explain the improvement point of the dialog response of the target group based on the analysis data.”
“Please compare and explain the features of the users included in the target group based on the analysis data.”
“Based on the analysis data, please identify the top users (users with high scores), improved users (users whose scores have improved), low-level users (users with low scores), and degraded users (users whose scores have worsened) among the users included in the target group.”
“Based on the analysis data, please output the improvement points, items showing change, likelihood of achieving goals, and comparison results.”T

he directives in the present disclosure include a directive for causing the generative AI 80 to output an analysis result for analysis data. The directives include a directive in the form of a so-called zero shot prompt that directly and explicitly designates a task to be executed by the generative AI 80. In addition, the directives include a directive in the form of a few shot prompt that designates a task to be executed by the generative AI 80 based on a small number of input/output examples.

For example, in the case of a directive in the form called a few shot prompt, the directive includes an input/output example consisting of a pair of input data and output data, in which, in response to input data “analysis data”, output data “a sentence indicating an analysis result, analysis content, or the like”for the analysis data is output.

In addition, the following directive may be stored for analysis data of a plurality of organizations, groups, and the like in a predetermined company.
“Based on the analysis data, please identify the top groups (groups with high scores), improved groups (groups whose scores have improved), low-level groups (groups with low scores), and degraded groups (groups whose scores have worsened).”

In addition, the directives for generating input data may include a directive supporting a suggestion of a good part, a part to be improved, or the like of the way of speaking in the dialog based on the reading aloud text (analysis data) relating to the dialog.
“Please explain the good part and part to be improved in the dialog response of the target user based on the reading aloud text.”
“Please explain the good part and part to be improved in the dialog response of the target group based on the reading aloud text.”

As the directive, one predetermined directive may be preset and stored as a specified value.

As the directive, a predetermined directive may be selected from a plurality of directives and stored.

For example, the presentation processing page in step S101 may receive input of a directive. Specifically, a plurality of directives may be presented to the user on the presentation processing page, and a predetermined directive selected by an input operation by the user may be stored. For example, the user may select a predetermined directive in accordance with the content of the comment desired to be obtained in the presentation processing.

It should be noted that a character string associated with a plurality of directives may be stored in the item of directives of the target record of the comment table 1021. Thus, the directive and the analysis data are stored in association with each other in the target record of the comment table 1021.

In step S104, the presentation unit 1042 of the server 10 executes an input data creation step of creating input data to be input to the generative AI based on the analysis data acquired in the analysis data acquisition step.

The input data creation step is a step of creating input data based on at least one of a directive for outputting an improvement point in a dialog based on the analysis data, a directive for outputting a item showing change in the dialog based on the analysis data, a directive for outputting a goal achievement status of an operator or a group to which a plurality of operators belong based on the analysis data, and a directive for outputting a comparison result for each of the plurality of operators or each of the plurality of groups based on the analysis data.

Specifically, the presentation unit 1042 of the server 10 creates input data called a prompt to be input to a generative AI, based on the directive and the analysis data stored in the comment table 1021.

Examples of the input data are shown below. cl Input Data

Please explain the features of the dialog response of the target user A based on the analysis data.

### #Analysis Data:

Dialog score: 70

### Voice Features:

Voice score: 60
Talk: Listen ratio: 0.6 (ratio of user talking time to listener talking time)
Overlap count: 10 (number of times user and listener speeches overlapped)
Silence count: 15 (number of times silence occurred during conversation)
Fundamental frequency: 110 (fundamental frequency of user's speech)
Intonation strength: 0.5 (intonation strength of user's speech)

### Language Features:

Language score: 30
Keyword occurrence count: 20 (number of times a specific keyword appeared during dialog)
Word diversity: 0.75 (index indicating diversity of words used)
Length of spoken sentence: 50 (average length of user's spoken sentence)
Noun usage frequency: 0.3 (Noun usage frequency)
Verb usage frequency: 0.2 (Verb usage frequency)
Adjective usage frequency: 0.1 (Adjective usage frequency)
Emotional language usage: 5 (Number of times emotional words are used)
Topic distribution: {Topic A: 0.4, Topic B: 0.3, Topic C: 0.3} (Percentage of speeches per topic)

### Dialog-Related Indices: (Group Average)

Index score: 80
Number of calls made: 100 (Number of calls made during a specific period of time, e.g., one week)
Call duration: 300 minutes (total duration of calls in the same period)

### #Output Result:

In step S104, executed as the input data creation step is a step of creating input data based on at least one of: information indicating one or more operators or one or more groups determined to have an excellent dialog based on a score for determining the quality of the dialog for each operator or group to which the operators belong; and information indicating one or more operators or one or more groups determined not to have an excellent dialog based on a score for determining the quality of the dialog for each operator or group to which the operators belong.

Examples of the input data are shown below.

The input data may include analysis data of respective users (users A to C) included in the group.

### Input Data

Please compare and explain the features of users included in the target group A based on the analysis data.
#Target group A: Composed of user A, user B, user C, and user D

### #Analysis Data:

### Comparison Results (Ranking Information)

User A's comparison result: (Voice Score: 1st, Language Score: 2nd, Index Score: 4th, Dialog Score: 2nd)
User B's comparison result: (Voice Score: 2nd, Language Score: 1st, Index Score: 3rd, Dialog Score: 4th)
User C's comparison result: (Voice Score: 4th, Language Score: 3rd, Index Score: 1st, Dialog Score: 2nd)
User D's comparison result: (Voice Score: 3rd, Language Score: 4th, Index Score: 2nd, Dialog Score: 1st)
Dialog score: 70 (group average)

### Voice Features: (Group Average)

Voice score: 60
Talk: Listen ratio: 0.6 (ratio of user talking time to listener talking time)
Overlap count: 10 (number of times user and listener speeches overlapped)
Silence count: 15 (number of times silence occurred during conversation)
Fundamental frequency: 110 (fundamental frequency of user's speech)
Intonation strength: 0.5 (intonation strength of user's speech)

### Language Features: (Group Average)

Language score: 30
Keyword occurrence count: 20 (number of times a specific keyword appeared during dialog)
Word diversity: 0.75 (index indicating diversity of words used)
Length of spoken sentence: 50 (average length of user's spoken sentence)
Noun usage frequency: 0.3 (Noun usage frequency)
Verb usage frequency: 0.2 (Verb usage frequency)
Adjective usage frequency: 0.1 (Adjective usage frequency)
Emotional language usage: 5 (Number of times emotional words are used)
Topic distribution: {Topic A: 0.4, Topic B: 0.3, Topic C: 0.3} (Percentage of speeches per topic)

### Dialog-Related Indices: (Group Average)

Index score: 80
Number of calls made: 100 (Number of calls made during a specific period of time, e.g., one week)
Call duration: 300 minutes (total duration of calls in the same period)

The presentation unit 1042 of the server 10 stores the created input data in the item of input data of the target record of the comment table 1021.

In step S105, the presentation unit 1042 of the server 10 executes a response reception step of receiving the response content obtained by transmitting the input data generated in the input data generation step to the generative AI.

Specifically, the presentation unit 1042 of the server 10 transmits the input data generated in step S104 to the generative AI 80 as input data (prompt). The generative AI 80 outputs response data to the server 10 as a response. The presentation unit 1042 of the server 10 receives and accepts the response data to the input data.

In step S106, the presentation unit 1042 of the server 10 executes a comment presentation step of presenting a comment message including the response content received in the response reception step to a predetermined operator.

Specifically, the presentation unit 1042 of the server 10 creates comment data based on the response content received in step S105.

The presentation unit 1042 of the server 10 creates the comment data by combining the target user, the information for identifying each user belonging to the target group, and the analysis period with at least one or more of the response content. The response content itself may be used as comment data. It should be noted that, in the processing of this flowchart, each step may be repeatedly executed to obtain comment data.

An example of the comment data is shown below.

### Comment Data

The features of the dialog response during a period (Y-M-D to Y-M-D) of user A (name, affiliation, etc.) are as follows.

### #Features of Dialog Response:

(Response content from generative AI 80)

An example of the comment data is shown below.

### Comment Data

The features of each user in the period (Y-M-D to Y-M-D) of group A are as follows.
User A (name, affiliation, etc.)
User B (name, affiliation, etc.)
User C (name, affiliation, etc.)
User D (name, affiliation, etc.)

### #Features of Each User:

(Response content from generative AI 80)

An example of the comment data is shown below.

### Comment Data

The good points and improvement points in the way of speaking of user A (name, affiliation, etc.) during the period (Y-M-D to Y-M-D) are as follows. #Good points and improvement points in the way of speaking
(Response content from generative AI 80) The presentation unit 1042 of the server 10 stores the created comment data in the item of comment data in the target record of the comment table 1021.

In step S106, the presentation unit 1042 of the server 10 executes a comment presentation step of presenting a comment message including the response content received in the response reception step to a predetermined user.

FIG. 12 is a screen example of the comment screen D1 showing the operation of the comment processing. The comment screen D1 includes comment information D11 and analysis data D12. The comment information includes a directive D111 and a response content D112 from the generative AI 80. The analysis data D12 includes contents that visually represent, through graphs or the like, the data of the voice features, linguistic features, and dialog-related indices included the analysis data described above.

Specifically, the presentation unit 1042 of the server 10 transmits the created comment information to the first user terminal 20. For example, the presentation unit 1042 of the server 10 may transmit a message including the comment information (comment message) to the mail address, chat account, or the like of the first user. The display 2081 of the first user terminal 20 presents the received comment message to the first user.

The control unit 204 of the first user terminal 20 displays the comment data in the comment information D11 of the comment screen D1. The control unit 204 of the first user terminal 20 displays the response content from the generative AI 80 in the response content D112 of the comment screen D1. The control unit 204 of the first user terminal 20 may display the directive in the directive D111 of the comment screen D1. In addition, the control unit 204 of the first user terminal 20 may display the analysis data created in step S103 in the analysis data D12 of the comment screen D1.

In step S106, as the comment presentation step, a step of presenting a comment message is executed every predetermined period of time.

Specifically, in the present disclosure, a configuration in which the presentation processing is executed based on an operation by the first user is disclosed as an example, but the present disclosure is not limited thereto. The presentation unit 1042 of the server 10 may be configured to periodically distribute a comment message based on the comment information on the target user and the target group created by executing the presentation processing periodically (every day, every week, every month) to a predetermined user such as a manager engaged in management work who manages a plurality of operators.

In step S106, as the comment presentation step, a step of presenting a comment message including the response content received in the response reception step together with the analysis data acquired in the analysis data acquisition step is executed.

Specifically, the presentation unit 1042 of the server 10 may include the analysis data created in step S103 in the comment information. The presentation unit 1042 of the server 10 transmits the comment message including the analysis data to the first user terminal 20. The control unit 204 of the first user terminal 20 displays the comment information together with the analysis data in the analysis data D12 of the comment screen D1. Thus, the first user can confirm, together with the comment information, the content of the analysis data which is the source of the comment information. The first user can easily and deeply understand the content of the analysis data with reference to the content of the comment message.

### Basic Hardware Configuration of Computer

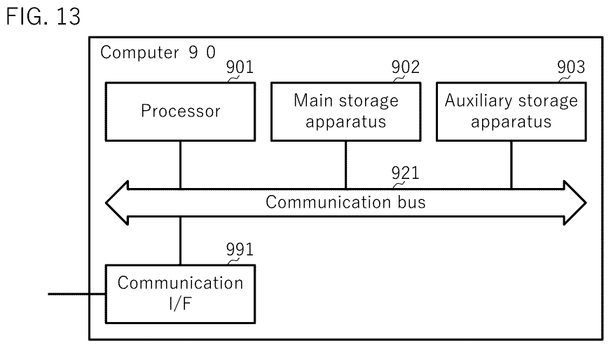

FIG. 13 is a block diagram showing a basic hardware configuration of the computer 90. The computer 90 includes at least a processor 901, a main storage apparatus 902, an auxiliary storage apparatus 903, and a communication interface (IF) 991. These are electrically connected to each other by a communication bus 921.

The processor 901 is hardware for executing an instruction set described in a program. The processor 901 is composed of an arithmetic unit, a register, a peripheral circuit, and the like.

The main storage apparatus 902 is used to temporarily store a program, data to be processed by the program, etc., and the like. For example, it is a volatile memory such as a dynamic random access memory (DRAM).

The auxiliary storage apparatus 903 is a storage apparatus for storing data and programs. For example, it is a flash memory, a hard disc drive (HDD), a magneto-optical disk, a CD-ROM, a DVD-ROM, a semiconductor memory, or the like.

The communication IF 991 is an interface for inputting and outputting signals to communicate with other computers through a network using a wired or wireless communication standard.

The network is composed of various mobile communication systems, etc. constructed by the Internet, a LAN, a wireless base station, etc. For example, the network includes a 3G, 4G, or 5G mobile communication system, long term evolution (LTE), a wireless network (such as Wi-Fi (registered trademark)) connectable to the Internet by a given access point, and the like. In the case of wireless connection, examples of the communication protocol include Z-Wave (registered trademark), ZigBee (registered trademark), and Bluetooth (registered trademark). In the case of wired connection, the network includes ones with direct connection by an universal serial bus (USB) cable or the like.

It should be noted that the computer 90 can be virtually realized by distributing all or part of each hardware configuration to a plurality of computers 90 and interconnecting them via a network. As described above, the computer 90 is a concept that includes not only the computer 90 housed in a single housing or case but also a virtualized computer system.

### Basic Functional Configuration of Computer 90

A functional configuration of the computer realized by the basic hardware configuration (FIG. 13) of the computer 90 will be described. The computer includes at least functional units of a control unit, a storage unit, and a communication unit.

The functional units of the computer 90 may be realized by distributing all or part of the functional units to a plurality of computers 90 connected to each other through a network. The computer 90 is a concept that includes not only a single computer 90 but also a virtualized computer system.

The control unit is realized by the processor 901 reading out various programs stored in the auxiliary storage apparatus 903, loading them into the main storage apparatus 902, and executing processes in accordance with the programs. The control unit can realize functional units that perform various types of information processing depending on the type of program. Thus, the computer is realized as an information processing apparatus that performs information processing.

The storage unit is realized by the main storage apparatus 902 and the auxiliary storage apparatus 903. The storage unit stores data, various programs, and various databases. In addition, the processor 901 can reserve a storage area corresponding to the storage unit in the main storage apparatus 902 or the auxiliary storage apparatus 903 in accordance with a program. In addition, the control unit can cause the processor 901 to execute processing for adding, updating, and deleting data stored in the storage unit in accordance with various programs.

The database refers to a relational database for managing a set of data, called a tabular table or master, structurally defined by rows and columns, in relation to each other. In the database, a table is called a table or a master, a table column is called a column, and a table row is called a record. In the relational database, relationships between tables or masters can be set so that they are associated with each other.

Normally, a column as the primary key for uniquely identifying the record is set in each table or each master, but it is not necessary to set the primary key for a column. The control unit can cause the processor 901 to execute addition, deletion, and update of a record in a specific table or master stored in the storage unit in accordance with various programs.

Further, the information processing apparatus and the information processing system according to the present disclosure can be understood as manufactured by storing data, various programs, and various databases in the storage unit.

It should be noted that the database or master in the present disclosure may include any data structure (list, dictionary, associative array, object, or the like) in which information is structurally defined. The data structure also includes data that can be regarded as a data structure by combining the data with a function, a class, a method, or the like described in any programming language.

The communication unit is realized by the communication IF 991. The communication unit realizes the function of communicating with another computer 90 through a network. The communication unit can receive information transmitted from another computer 90 and input the information to the control unit. The control unit can cause the processor 901 to execute information processing on the received information in accordance with various programs. Further, the communication unit can transmit information output from the control unit to another computer 90.

### Appendixes

The matters described in the above embodiments will be appended below.

### Appendix 1

A program for causing a computer including a processor and a storage unit to process information on a dialog between a plurality of users, wherein the program causes the processor to execute: an analysis data acquisition step of acquiring analysis data obtained by analyzing the dialog (S103); and an input data creation step (S104) of creating input data to be input to a generative AI, based on the analysis data acquired in the analysis data acquisition step.

This makes it possible to create input data, such as a prompt, to be input to a generative AI such as a large-scale language model for obtaining a response content (comments) in a manner that is easy for users to understand regarding analysis data relating to a dialog performed between a plurality of users.

### Appendix 2

The program according to Appendix 1, wherein the analysis data includes information on a predetermined dialog of at least one of a voice feature relating to voice uttered by a speaker, a language feature relating to a spoken content, and a number of times of calls made and a call duration relating to the dialog.

This makes it possible to create input data, such as a prompt, to be input to a generative AI such as a large-scale language model for obtaining a response content (comments) in a manner that is easy for users to understand regarding numerical values such as voice features, linguistic features, the number of calls made, call information, etc. relating to a dialog performed between a plurality of users.

### Appendix 3

The program according to Appendix 1 or 2, wherein the analysis data includes a statistical value of features in a plurality of dialogs of a plurality of users who performed the dialog or a comparison result obtained by comparing features between the plurality of users who performed the dialog.

This enables the evaluation of a dialog of users or a group to which a plurality of users belong, based on a statistical value such as an average value or a median value of features of each user, as well as a comparison result such as a ranking obtained by comparing features of users.

### Appendix 4

The program according to any one of Appendixes 1 to 3, wherein the input data creation step (S104) is a step of creating input data based on at least one of: a directive for outputting an improvement point in the dialog based on the analysis data; a directive for outputting an item showing change in the dialog based on the analysis data; a directive for outputting a goal achievement status of an operator or a group to which a plurality of operators belong based on the analysis data; and a directive for outputting a comparison result for a plurality of operators or a plurality of groups based on the analysis data.

This makes it possible to, when the user is an operator or the like who handles customer interactions, create input data, such as a prompt, to be input to a generative AI such as a large-scale language model for obtaining a suitable response content (comments) that helps the operator improve their dialog content based on dialog-related analysis data.

### Appendix 5

The program according to any one of Appendixes 1 to 4, wherein the input data creation step (S104) is a step of creating input data based on at least one of: information indicating one or more operators or one or more groups determined to have an excellent dialog based on a score for judging quality of the dialog for each operator or a group to which a plurality of operators belong; and information indicating one or more operators or one or more groups determined not to have an excellent dialog based on a score for judging quality of the dialog for each operator or a group to which a plurality of operators belong.

This makes it possible to, when the user is an operator or the like who handles customer interactions, create input data, such as a prompt, to be input to a generative AI such as a large-scale language model for obtaining, as a response content (comments), an operator who has an excellent dialog or a group to which such operators belong, or an operator who does not have an excellent dialog or a group to which such operators belong.

### Appendix 6

The program according to any one of Appendixes 1 to 5, wherein the analysis data acquisition step (S103) is a step of acquiring the analysis data obtained by analyzing the dialog performed by a predetermined operator, and the program causes the processor to execute: a response reception step (S105) of receiving a response content obtained by transmitting the input data created in the input data creation step to a generative AI; and a comment presentation step (S106) of presenting a comment message including the response content received in the response reception step to the predetermined operator.

This allows users such as operators to obtain, from a generative AI, a dialog-related response content (comments) in a manner that is easy for users to understand.

### Appendix 7

The program according to any one of Appendixes 1 to 5, wherein the analysis data acquisition step (S103) is a step of acquiring the analysis data on each of the plurality of operators, the analysis data being obtained by analyzing a plurality of dialogs performed by a plurality of operators, and the program causes the processor to execute: a response reception step (S105) of receiving a response content obtained by transmitting the input data created in the input data creation step to a generative AI; and a comment presentation step (S106) of presenting a comment message including the response content received in the response reception step to a predetermined user.

This allows managers and other executives who manage operators to obtain, from a generative AI, a dialog-related response content (comments) with respect to dialogs of a plurality of operators they manage in a manner that is easy for users to understand.

### Appendix 8

The program according to Appendix 6 or 7, wherein the analysis data acquisition step (S103) is a step of acquiring the analysis data in a predetermined period, and the comment presentation step (S106) is a step of presenting the comment message every predetermined period.

This makes it possible to obtain, from a generative AI, a dialog-related response content (comments) every predetermined period in a manner that is easy for users to understand.

### Appendix 9

The program according to any one of Appendixes 6 to 8, wherein the comment presentation step (S106) is a step of presenting the comment message including the response content received in the response reception step, together with the analysis data acquired in the analysis data acquisition step.

This makes it possible to confirm dialog-related analysis data together with a response content. It enables more effective confirmation of the analysis data.

### EXPLANATION OF REFERENCE NUMERALS

1: system, 10: server, 101: storage unit, 104: control unit, 106: input apparatus, 108: output apparatus, 20: first user terminal, 201: storage unit, 204: control unit, 206: input apparatus, 208: output apparatus, 30: second user terminal, 301: storage unit, 304: control unit, 306: input apparatus, 308 output apparatus, 50: voice server (PBX), 501: storage unit, 504: control unit, 506: input apparatus, 508: output apparatus, 80: generative AI, 801: storage unit, 804: control unit, 806: input apparatus, 808: output apparatus

1. An information processing apparatus for processing information on a dialog between a plurality of users, the apparatus comprising:
processing circuitry configured to:
acquire analysis data obtained by analyzing the dialog; and
create input data to be input to a generative AI, based on the acquired analysis data.

2. The information processing apparatus according to claim 1, wherein
the analysis data includes information on a predetermined dialog of at least one of a voice feature relating to voice uttered by a speaker, a language feature relating to a spoken content, and a number of times of calls made and a call duration relating to the dialog.

3. The information processing apparatus according to claim 1, wherein
the analysis data includes a statistical value of features in a plurality of dialogs of a plurality of users who performed the dialog or a comparison result obtained by comparing features between the plurality of users who performed the dialog.

4. The information processing apparatus according to claim 1, wherein
the processing circuitry is configured to create the input data based on at least one of:
a directive for outputting an improvement point in the dialog based on the analysis data;
a directive for outputting an item showing change in the dialog based on the analysis data;
a directive for outputting a goal achievement status of an operator or a group to which a plurality of operators belong based on the analysis data; and
a directive for outputting a comparison result for a plurality of operators or a plurality of groups based on the analysis data.

5. The information processing apparatus according to claim 1, wherein
the processing circuitry is configured to create the input data based on at least one of:
information indicating one or more operators or one or more groups determined to have an excellent dialog based on a score for judging quality of the dialog for each operator or a group to which a plurality of operators belong; and
information indicating one or more operators or one or more groups determined not to have an excellent dialog based on a score for judging quality of the dialog for each operator or a group to which a plurality of operators belong.

6. The information processing apparatus according to claim 1, wherein
the processing circuitry is configured to acquire the analysis data obtained by analyzing the dialog performed by a predetermined operator, and
the processing circuitry is further configured to:
receive a response content obtained by transmitting the created input data to a generative AI; and
presents a comment message including the received response content to the predetermined operator.

7. The information processing apparatus according to claim 1, wherein
the processing circuitry is configured to acquire the analysis data on each of the plurality of operators, the analysis data being obtained by analyzing a plurality of dialogs performed by a plurality of operators, and
the processing circuitry is further configured to:
receive a response content obtained by transmitting the created input data to a generative AI; and
present a comment message including the received response content to a predetermined user.

8. The information processing apparatus according to claim 6, wherein
the processing circuitry is configured to acquire the analysis data in a predetermined period, and
present the comment message every predetermined period.

9. The information processing apparatus according to claim 6, wherein
the processing circuitry is configured to present the comment message including the received response content, together with the acquired analysis data.
